(19) United States
(12) Patent Application Publication
(10) Pub. No.: US 2025/0364893 A1
(43) Pub. Date: Nov. 27, 2025

(54) SEMICONDUCTOR DEVICE AND POWER CONVERSION DEVICE

(71) Applicant: Mitsubishi Electric Corporation, Tokyo (JP)

(72) Inventor: Chihiro KAWAHARA, Chiyoda-ku, Tokyo (JP)

(73) Assignee: Mitsubishi Electric Corporation, Tokyo (JP)

(21) Appl. No.: 18/874,211

(22) PCT Filed: Jun. 21, 2022
(86) PCT No.: PCT/JP2022/024679

§ 371 Date: Dec. 12, 2024

(51) Int. Cl. H02M 1/08; H02M 7/537; H03K 17/14

(52) U.S. Cl. CPC H02M 1/08; H03K 17/145; H02M 7/537

(57) ABSTRACT

In a semiconductor device that drives and controls a semiconductor element, a current control unit is provided to pass a current of pulse shape between a control terminal and a negative electrode terminal of the semiconductor element. A peak detection circuit detects a peak value of a voltage between the control terminal or the negative electrode terminal and a reference potential in a current supply period by the current control unit. A temperature estimation unit calculates an estimated temperature of the semiconductor element based on an output voltage of the peak detection circuit sampled by a voltage detection unit. The timing control unit causes the current control unit to operate to provide the current supply period during at least one of an on-period after the semiconductor element shifts to the on state; and an off-period after the semiconductor element shim to the off state.

### TECHNICAL FIELD

The present disclosure relates to a semiconductor device and a power conversion device.

### BACKGROUND ART

In a power converter using a power semiconductor element such as an insulated gate bipolar transistor (IGBT) and a metal oxide semiconductor field-effect transistor (MOSFET), an increase in density of current flowing through the power semiconductor element has been promoted for miniaturization.

However, increasing the current density increases an energy loss of the power semiconductor element and causes a temperature rise of the power semiconductor element. The power semiconductor element has a maximum allowable operating temperature specified by the properties of semiconductor materials thereof, and the like, and when the temperature is greater than the maximum allowable operating temperature, thermal runaway may occur in the power semiconductor element, which may cause destruction of the power semiconductor element. For this reason, in recent year, temperature management of power semiconductor elements has become more important.

In order to manage the temperature of the power semiconductor element as described above, a method is known, for example, for attaching a temperature sensor such as a thermistor to a fin or the like for cooling the power semiconductor element to indirectly estimate the temperature of the power semiconductor element. However, since the thermal time constant from the power semiconductor element to the fin is generally large, this method may not be able to measure a rapid change in the temperature oldie power semiconductor element due to a load variation in a short time.

One of the methods for addressing this problem is disclosed in Japanese Patent Laying-Open No. 2020-72569 (PTL 1). With this method, information indicating a relationship between a temporal change in the gate voltage during a switching operation of the semiconductor device and the temperature of a power semiconductor element is stand in advance, and the temperature of the power semiconductor element is estimated from a time in which the gate voltage rises.

### CITATION LIST

### Patent Literature

PTL 1: Japanese Patent Laying-Open No. 2020-72569 SUMMARY OF INVENTION

### Technical Problem

However, the technique disclosed in PTL 1 needs a highly accurate measurement mechanism and a high-speed processor in order to measure the time in which the gate voltage rises, and providing such a measurement mechanism may restrict a reduction in size of the power module.

The present disclosure has been made in view of the above problems, and an object of the present disclosure is to provide a semiconductor device that drives and controls a power semiconductor element and has the function of estimating a temperature of the power semiconductor element without the need fora highly accurate measurement mechanism and a high-speed processor.

### Solution to Problem

According to an aspect of the present disclosure, a semiconductor for device that drives and controls a semiconductor element includes a driver circuit, a current control unit, a dining control unit, a peak detection circuit, a voltage detection unit, and a temperature estimation unit. The semiconductor element has a positive electrode terminal, a negative electrode terminal, and a control terminal, a drive voltage for controlling a main current flowing between the positive electrode terminal and the negative electrode terminal being applied to the control terminal. The driver circuit supplies the drive voltage to the control terminal to shift the semiconductor element between an on state and an off state. The current control unit is provided to peas a current of pulse shape between the control terminal and the negative electrode terminal. The timing control unit controls a timing of supply of the current by the current control Unit. The peak detection circuit outputs a peak value of an input voltage, the input voltage being a potential difference of the control terminal or the negative electrode terminal with respect to a reference potential in a current supply period by the current control unit. The voltage detection unit samples an output voltage of the peak detection circuit. The temperature estimation unit calculates an estimated temperature of the semiconductor element based on a detection voltage by the voltage detection unit. The timing control unit causes the current control unit to operate to provide the current supply period during at least one of: an on-period after the semiconductor element shifts to the on state; and an off-period after the semiconductor element shifts to the off state.

### Advantageous Effects of Invention

According to the present disclosure, it is possible to provide a semiconductor device capable of estimating a temperature of a semiconductor element, without a high-speed measurement mechanism and a high-speed processor, based on a peak value of a voltage between a control terminal or a negative electrode terminal and a reference potential when a current is supplied between the control terminal end the negative electrode terminal.

### BRIEF DESCRIPTION OF DRAWINGS

FIG. 1A is a configuration diagram illustrating an example of a power module according to a first embodiment.

FIG. 1B is a circuit diagram illustrating a configuration example of a current control unit in FIG. 1A.

FIG. 2A is a circuit diagram describing a first example of a connection position of the current control unit illustrated in FIG. 1B.

FIG. 2B is a circuit diagram describing a second example of the connection position of the current control unit illustrated in FIG. 1B.

FIG. 3 is a configuration diagram illustrating a modification of the power module in FIG. 1A.

FIG. 4 is a circuit diagram describing a configuration example of a peak detection circuit illustrated in FIG. 1A.

FIG. 5 is a timing chart for describing a temperature estimation method by a semiconductor device according to the first embodiment.

FIG. 6 is a circuit diagram describing a configuration of a peak detection circuit according to a modification of the fast embodiment.

FIG. 7 is a timing chart for describing a temperature estimation method by a semiconductor device according to the modification of the first embodiment.

FIG. 8 is a circuit diagram describing a first configuration example of a peak detection circuit according to a second embodiment.

FIG. 9 is a circuit diagram describing a second configuration example of the peak detection circuit according to the second embodiment.

FIG. 10 is a timing chart for describing a temperature estimation method by a semiconductor device according to a third embodiment.

FIG. 11 is a configuration diagram illustrating an example of a power module according to a fourth embodiment.

FIG. 12 is a timing chart for describing a thermal resistance and thermal impedance estimation method by a semiconductor device according to the fourth embodiment.

FIG. 13 is a flowchart describing a thermal resistance and thermal impedance calculation process by the semiconductor device according ding to the fourth embodiment.

FIG. 14 is a block diagram illustrating a configuration of a power conversion system to which a power conversion device according to the present embodiment having a semiconductor element mounted thereon is applied.

### DESCRIPTION OF EMBODIMENTS

Hereinafter, embodiments of the present disclosure will be described in detail with reference to the drawings. In the following description, the same or corresponding parts in the drawings are denoted by the same signs and the description thereof will not be repeated in principle.

### First Embodiment

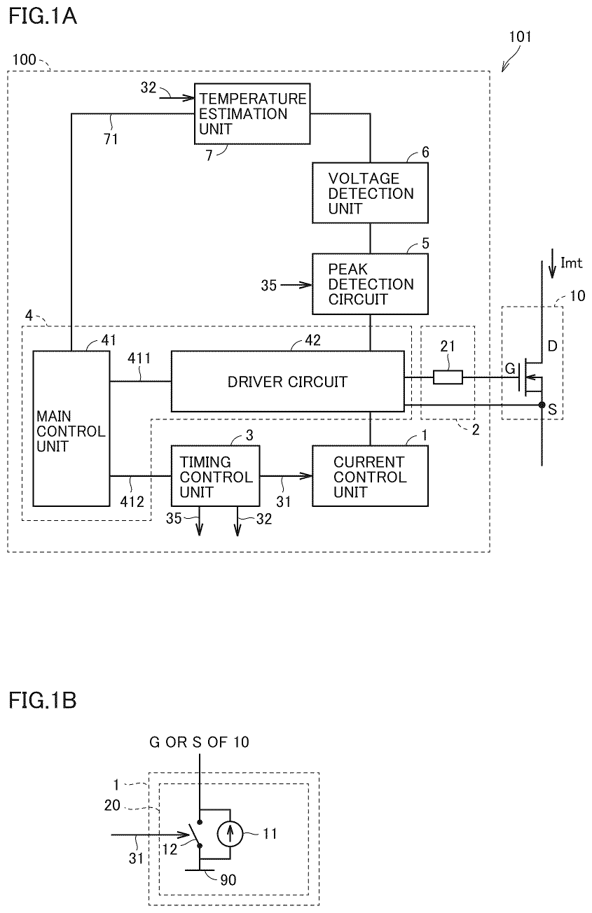

FIG. 1A is a configuration diagram illustrating an a ample of a power module 101 according to a fast embodiment. FIG. 1B is a circuit diagram illustrating a configuration example of a current control unit 1 in FIG. 1A. Referring to FIGS. 1A and 18, the configuration of power module 101 will be described below.

As illustrated in FIG. 1A, power module 101 includes a power semiconductor element 10 and a semiconductor device 100 that drives and controls power semiconductor element 10. Semiconductor device 100 controls switching of power semiconductor element 10 and measures an element temperature of power semiconductor element 10.

Power semiconductor element 10 includes a positive electrode terminal (drain) D, a negative electrode terminal (source) S, and a control terminal (gate) G. A main current lot flowing between positive electrode terminal D and negative electrode terminal S is controlled by a drive voltage applied to control terminal G.

Power semiconductor element 10 may be any of a MOSFET, an IGBT, a metal-semiconductor field-effect transistor (MESFET), a bipolar transistor, and the like. A case where power semiconductor element 10 is a MOSFET will be described below as an example. Asa material of power semiconductor element 10, SiC, GeN, Ga₂O₃, diamond, or the like may be used other than Si.

Semiconductor device 100 includes a gate drive unit 4, current control unit 1, a gate wiring unit 2, a timing control unit 3, a peak detection circuit 5, a voltage detection unit 6, and a temperature estimation unit 7. Here, gate drive unit 4 includes a drives circuit 42 as a drive control unit that is connected to power semiconductor element 10 and drives power semiconductor element 10, and a main control unit 41 that controls driver circuit 42.

Control terminal G of power semiconductor element 10 is connected to driver circuit 42 through resistance dement 21 provided in gate wiring unit 2. Gate wiring unit 2 represents a series of loop wirings connecting control terminal G and negative electrode terminal S of power semiconductor element 10 and driver circuit 42. In the example of FIG. 1A, resistance element 21 is connected between driver circuit 42 and control terminal G of power semiconductor element 10.

Current control unit us connected to driver circuit 42 and supplies a current, through driver circuit 42, to a pub formed between control terminal G and negative electrode terminal S of power semiconductor element 10. As illustrated in FIG. 18, current control unit 1 includes a pulse current supply 20 for supplying a pulsed current. More specifically, pulse current supply 20 includes, for example, a current supply 11 that supplies a constant current, and a current control switch 12 connected in parallel to current supply 11. Current control switch 12 is t used on croft in response to a switch control signal 31 from timing control unit 3.

When current control switch 12 is switched from on to of, pulse current apply 20 starts outputting the current, and when current control switch 12 is switched from off to on, pulse current supply 20 ends the output of the current in this way, the output current of current control unit 1 is controlled ed in a pulsed roamer in response to on and off of current control switch 12.

Various types of current supplies that are commonly known can be used as current supply 11. For example, a bipolar transistor, a current mirror, or a current supply provided with a resistor on the output side of a constant voltage source may be used. In addition, current supply 11 may be a current source that outputs a current or may be a current sink that draws a current depending on the circuit configuration. As current control switch 12, a switching element that operates at a relatively high speed such as a MOSFET can be used, for example. When measurement accuracy is required, an ultrafast device such as a GaN high electron mobility transistor (HEMT) may be used as current control switch 12.

As illustrated in FIG. 18, one end of each of current supply 11 and current control switch 12 is connected to a reference potential node 90 that applies a reference potential. Here, the reference potential is, for example, a control ground of driver circuit 42 or a power supply voltage of driver circuit 42.

The other end of each of current supply 11 and current control switch 12 is directly or indirectly electrically connected to control terminal G or negative electrode terminal S of power semiconductor element 10. When indirectly connected, the other end of each of current supply 11 and current control switch 12 is connected ted to control terminalG(gate) or negative electrode terminal S (source) of power semiconductor element 10 visa semiconductor switching element or a resistor which is another electronic component mounted on driver circuit 42.

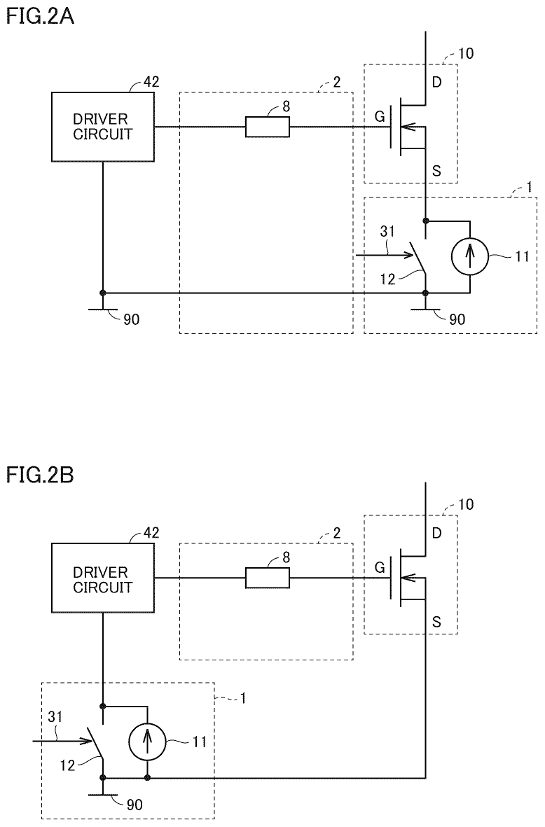

FIGS. 2A and 2B illustrate circuit diagrams describing first and second examples of a connection position of current control unit 1, respectively.

More specifically. FIG. 2A illustrates a configuration example in which the above-described other end (side that is not connected to reference potential node 90) of each of current supply 11 and current control switch 12 is electrically connected to negative electrode terminal S of power semiconductor element 10. In FIG. 2A, current control unit 1 is connected to a position where current control unit 1 supplies the current from the negative electrode terminal S side of power semiconductor element 10.

On the other band, FIG. 2B illustrates a configuration example in which the above described other end of each of current supply 11 and current control switch 12 is electrically connected to control terminal G of power semiconductor element 10. In FIG. 2B, current control unit 1 is indirectly connected to control terminal G via driver circuit 42, whereby current control unit 1 is connected to a position wham current control unit 1 supplies the current from the control terminal G side of power semiconductor element 10. A case where the other end of each of current supply 11 and current control switch 12 is electrically connected to negative electrode terminal S of power semiconductor element 10 (FIG. 2A) will be described below as an example.

Referring again to FIG. 1A, timing control unit 3 outputs a switch control signal 31 for controlling current control switch 12 of current control unit 1 on the basis of a command 412 from main control unit 41 of gate drive unit 4. As previously described, main control unit 41 controls driver circuit 42 and timing control unit 3. As main control unit 41, a functional device such as a microprocessor, an application specific integrated circuit (ASIC), or a field programmable gate array (FPGA) is used, for example.

Although timing control unit 3 and gate drive unit 4 are explicitly distinguished from each other in FIG. 1A for the sake of description, timing control unit 3 may be included in main control unit 41. In addition, driver circuit 42 and timing control unit 3 may be mounted on the sense substrate, or all of main control unit 41, driver circuit 42, timing control unit 3, and current control unit 1 may be mounted on the same substrate.

Peak detection circuit 5 is connected to driver circuit 42 to receive a voltage (inter-terminal voltage) between both ends of current supply 11. A configuration example of peak detection circuit 5 will be described below.

Voltage detection unit 6 detects an output voltage of peak detection circuit 5. Temperature estimation unit 7 calculates an estimated temperature of power semiconductor element 10 from an output voltage value of peak detection circuit 5 at prescribed timing, based on the detection value of voltage detection unit 6 and control information 32 of timing control unit 3. For example, as described below, temperature estimation unit 7 calculates a resistance value of power semiconductor element 10 from the above-described output voltage value. Furthermore, more, temperature estimation unit 7 generates temperature information 71 including the estimated temperature. The estimated temperature is obtained by converting the newly measured resistance value of power semiconductor element 10 into a temperature through comparison with conversion data indicating a relationship between resistance values and element temperatures that are predetermined based on die measurement values by preliminary experiments on an actual machine.

Temperature information 71 is fed beck to main control unit 41. In a case where the temperature exceeds a predetermined value, main control unit 41 can change a drive pattern so as to reduce the loss of the power semiconductor element, and can further output warning information to a host system. Although main control unit 41 and temperature estimation unit 7 are illustrated as separate components in FIG. 1A for the sake of description, the function of temperature estimation unit 7 may be included in main control unit 41.

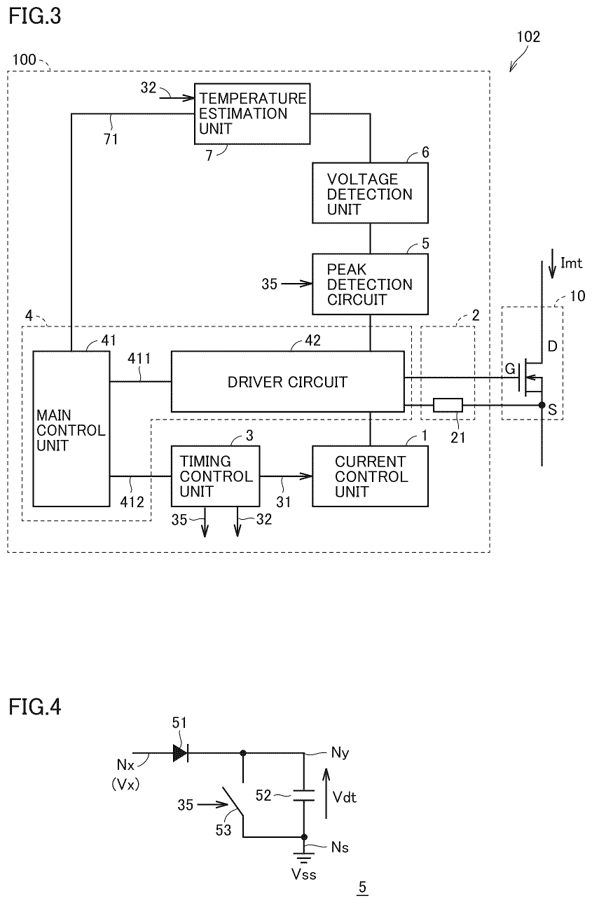

FIG. 3 is a configuration diagram illustrating a modification of power module 101 in FIG. 1A. Power module 101 illustrated in FIG. 3 is different from power module 101 in FIG. 1A in that in gate wiring portion 2, resistance element 21 is connected to a wiring (source wiring) connected to negative electrode terminal S, not a wiring (gate waging) connected to control terminal G. In this case as well, resistance element 21 causes a voltage drop in gate wiring portion 2 in accordance with the current flowing between control terminal G and negative electrode terminal S. The other configurations in FIG. 3 are the same as those in FIG. 1A, and thus, the same or corresponding parts are denoted by the same reference signs, and the description thereof will not be repeated. In addition, although resistance element 21 is clearly illustrated outside power semiconductor element 10 in each of FIGS. 1A and 3, a gate resistance may not be provided outside power semiconductor element 10 depending on applications.

### [Temperature Estimation Method for Power Semiconductor Element]

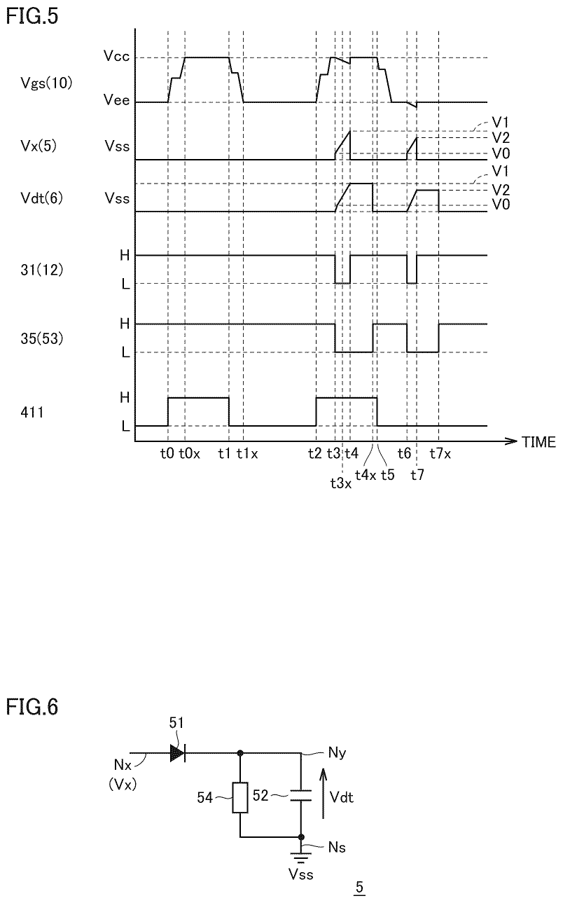

A method for estimating the temperature of power semiconductor element 10 by semiconductor device 100 in FIG. 1A will be more specifically described below. FIG. 4 illustrates a configuration example of peak detection circuit 5 in FIG. 1A. FIG. 5 illustrates a timing chart for describing a temperature estimation method by semiconductor device 100 in which peak detection circuit 3 illustrated in FIG. 4 is arranged.

As illustrated in FIG. 4, peak detection circuit 5 can be configured by, for example, a detection circuit having a diode 51, a capacitor 52 and a discharge switch 53. Diode 31 is connected between an input node Nx and a node Ny, with a direction from input node Nx to node Ny being a forward direction. Capacitor 52 is connected between node Ny and a node Ns. A potential of node Ns is also denoted as Vss. Node Ns has the same potential as that of reference potential node 90 in FIG. 1B and the Tike, and an input voltage Vx of peak detection circuit 5 corresponds to a potential difference of node Na with respect to node Na, i.e., a potential difference of control terminal G or negative electrode terminal S with respect to the reference potential.

Discharge switch 53 is connected in parallel to capacitor 52 and is turned on and off in response to a switch control signal 35 from timing control unit 3. Discharge switch 53 can be configured by, for example, a MOSFET having a small leakage current in order to hold the potential of node Ny in an off state.

As described above, peak detection circuit 5 is connected to receive the voltage (inter-terminal voltage) between both ends of current supply 11. Therefore, when current control unit 1 is connected in the manner of FIG. 2A, input node Na and node Ns of peak detection circuit 5 are directly or indirectly connected to negative electrode terminal S of power semiconductor element 10 and reference potential node 90. That is, input node Na is electrically connected to negative electrode terminal S of power semiconductor element 10. On the other hand, when current control unit 1 is connected in the manner of FIG. 28, input node Nx and node Na of peak detection circuit 5 are directly or indirectly connected to control terminal G of power semiconductor element 10 and reference potential node 90. That is, input node Na is electrically connected to control terminal G of power semiconductor element 10.

In peak detection circuit 5, when a voltage of input node Na is higher than a voltage of node Ny, input voltage Vx is transmitted to node Ny and held by capacitor 52. On the other hand, when the voltage of input node Na is lower than the voltage of node Ny, input voltage Vx is not omitted to node Ny, and thus, capacitor 52 holds and outputs a peak value of a voltage that has been previously transmitted by diode 51.

In FIG. 4, input node Nx corresponds to an example of “first node”, node Ny corresponds to an example of “second node”, and diode 51 corresponds to an example of “fast diode”.

Voltage detection unit 6 samples and detects a voltage (Vdet) of capacitor 52, i.e., the output voltage of peak detection circuits. In the following description, the voltage of capacitor 52 corresponding to the input voltage of voltage detection unit 6 is also referred to as a detection voltage Vdet. When discharge switch 53 is in an on state, detection voltage Vdet is cleared (Vdet=Va).

The temperature estimation method by semiconductor device 100 (FIG. 1A) according to the first embodiment will be described with reference to FIG. 5. In FIG. 5, waveforms up to time t2 indicate voltage waveforms and signal waveform during a normal switching operation in which temperature measurement is not performed, and waveforms after time t2 indicate voltage waveforms and signal waveforms when temperature measurement is performed together with the switching operation. First, the operation of semiconductor device 100 during a normal switching operation will be described.

### (Operation of Semiconductor Device During Normal Operation)

Driver circuit 42 outputs a positive potential Vcc higher than a threshold voltage and a potential Vee (usually, a negative potential or a zero potential) less than or equal to the threshold voltage in order to drive power semiconductor element 10. Specifically, driver circuit 42 applies positive potential Vcc or negative or zero potential Vee as a gate voltage to control terminal G of power semiconductor element 10 on the basis of a driver input signal 411 from main control unit 41. Asa result, driver circuit 42 shifts power semiconductor element 10 between the on state and the off state.

During the normal operation, timing control unit 3 controls current control switch 12 of current control unit 1 to be always in the on state. Therefore, when an enhancement type element such as an n-type MOSFET is used for current control switch 12, a logic high (H) level signal is constantly input as switch control signal 31 of current control switch 12. When a depression type element such as a p-type MOSFET is used for current control switch 12, a logic low (L) level signal is constantly input as switch control signal 31.

Specifically, referring to FIG. 5, when drives input signal 411 to driver circuit 42 changes from an L level to an H level at time t0 during a turn-on operation, positive potential Vcc is applied to control terminal G of power semiconductor element 10, so that a gate voltage Vgs rises. Gate voltage Vgs reaches positive potential Vice at time t0x after a rise period with a time constant that is dependent on the resistance value of resistance element 21 and the element capacitance of power semiconductor element 10.

At this time, the gate current supplied from driver circuit 42 to power semiconductor element 10 directly flows to reference potential node 90 via current control switch 12. In addition, the current from current supply 11 also flows to reference potential node 90 via current control switch 12 and is not output to driver circuit 42. Note that a Miller period in which gate voltage Vgs has a constant value is observed in the rise period between time t0 and time t0x.

In the case of a turn-off operation, driver input signal 411 changes from the H level to the L level at time t1. As a result, negative or zero potential Vee is applied to control terminal G of power semiconductor element 10, so that gate voltage Vp drops. Gate voltage Vp reaches negative or aero potential Vee at time t1x after a fell period as in the turn-on operation. As in the turn-on operation, the gate current flows to reference potential node 90 via current control switch 12. The current from current supply 11 flows to reference potential node 90 via current control switch 12 and is not output to driver circuit 42. Note that the Miller period is also observed in the fall period from times t1 to t1x.

### (Temperature Measurement Nt During On-Period)

Next, the operation of semiconductor device 100 when temperature measurement is performed will be described. The temperature is treasured in a period in which the gate voltage is stable, other than the rise period and the fall period of the gate voltage. The period in which the gate voltage is stable includes a period in which the gate voltage is stable at positive potential Vcc (hereinafter referred to as “on-period”) and a period in which the gate voltage is stable at negative or zero potential Vee (hereinafter referred to as “off-period”).

First, temperature measurement during the on-period will be described. Referring to FIG. 5, driver input signal 411 changes from the L level to the H level at time t2 corresponding to a turn-on command timing. Switch control signals 31 and 33 switch from the H level to the L level at time t3 after a lapse of a certain delay period from time t2. This delay time can be simply set as a time constant of the resistance value of resistance element 21 and the element capacitance of power semiconductor element 10 or longer.

When the delay time is chart, a gate drive current from driver circuit 42 also affects the detection voltage of voltage detection unit 6, which affects the accuracy of temperature measurement. On the other land, when the delay time is long, time 14 at which switch control signal 31 is returned to the H level is close to time t5 at which the turn-off is started. As a result, the gate drive current from driver circuit 42 also affects the detection voltage of voltage detection unit 6, which affects the accuracy of temperature measurement.

When switch control signal 31 is turned to the L level (time 13), current control switch 12 in FIG. 1B is turned off. Asa result, the current from current supply 11 flows not to reference potential node 90 but to power semiconductor element 10. That is, current control unit 1 supplies the current between control terminal G and negative electrode terminal 5. In this current supply period, input voltage Vx to peak detection circuit 5 is expressed by following Expression (1).

$$\begin{matrix}[ Expression 1 ] & \\ {V}_{x} ( t - t 3 ) = ( {R}_{g} + {R}_{gint} ) \cdot {I}_{g} + \frac{t - t 3}{{C}_{die}} \cdot {I}_{g} {\vert}_{t \geq t 3} & ( 1 )\end{matrix}$$

In Expression (1), Vx(t−t3) represents the input voltage of peak detection 20 circuit 5 at time t after time U. R_{gint} is a value of a gate resistance (internal gate resistance) in power semiconductor element 10. The internal gate resistance is created by a material such as polysilicon on power semiconductor element 10, for example. Alternatively, the internal gate resistance includes a parasitic resistance due to a gate wiring pattern on power semiconductor element 10.

R_{g} in Expression (1) represents the resistance on driver circuit 42 and the value of resistance element 21, and represents a resistance component other than the resistance caused by power semiconductor element 10 itself. Usually, R_{g} is provided by a resistance externally attached to power semiconductor element 10, which makes selection of resistance values and temperature characteristics relatively easy. C_{die} represents a capacitance value seen from the gate side (in the case of FIG. 2A) or the source side (in the case of FIG. 2B) of power semiconductor element 10. I_{g} represents a supply current from current supply 11.

In current control unit 1 (FIG. 1b and the like), when current control switch 12 is turned off, current injection from current supply 1110 power semiconductor element 10 is stoned. As a result, input voltage Vx is input to peak detection circuit 5 in accordance with Expression (1).

Specifically, first, voltage V0=(R_{g}+R_{gint})·I_{g} obtained by multiplying the total value of the internal gate resistance of power semiconductor element 10, resistance element 21, and the resistance on driver circuit 42 by the value of current supplied from current supply IL as represented by the first term on the right side of Expression (1) is constantly generated.

Furthermore, after time t3 at which current control switch 12 is turned of, input voltage Vx rises in accordance with (t−t3)·I_{g}/C_{die} due to charging of the parasitic capacitance of power semiconductor element 10 as represented by the second term on the rigid side of Expression (1). When parasitic capacitance C is constant and current I_{g} of current supply 11 has a constant value, input voltage Vx of peak detection circuit 5 rises linearly. Since the change in input voltage Vx is transmitted to capacitor 52 through node Ny in the process of the rise of input voltage Vx, detection voltage Wet of voltage detection unit 6 changes equivalently to input voltage Vx after time t3 (Vdet=Vx).

When switch control signal 31 is returned from the L level to the H level at time t4, current control switch 12 is turned on in current control unit 1, so that the current from current supply 11 flows to reference potential node 90. At the same time, an electric charge stored in the parasitic capacitance of power semiconductor element 10 is also discharged. When current control switch 12 is turned on, the inter-terminal voltage of current supply 11 becomes zero. Therefore, at time 14, input voltage Vx of peak detection circuit 5 becomes zero (Vx=0).

On the other hand, switch control signal 35 is maintained in the L level, and thus, discharge switch 53 is maintained in the off state in peak detection circuit 5. Therefore, after time t4, detection voltage Vdet of voltage detection unit 6 is maintained at the voltage value at time t3.

When switch control signal 35 changes from the L level to the H level at time t4x, discharge switch 53 is turned on in peak detection circuit 5 (FIG. 4), and thus, the voltage of capacitor 52 becomes zero. In response, detection voltage Vdet of voltage detection unit 6 changes to zero (Vdet=0). Note that time t4x can also be synchronized with a below-described turn-off command timing at which driver input signal 411 changes from the H level to the L level.

As a result, in temperature measurement during the on-period, an input voltage Vx(t4) described below is measured as detection voltage Vdet by voltage detection unit 6 during a period from times t4 to t4x.

$$\begin{matrix}[ Expression 2 ] & \\ {V}_{x} ( t 4 ) = ( {R}_{g} + {R}_{gint} ) \cdot {I}_{g} + \frac{t 4 - t 3}{{C}_{die}} \cdot {I}_{g} {\vert}_{t 4 \geq t 3} & ( 2 )\end{matrix}$$

When curvet I_{g} has a constant value and a time difference between times t3 and t4 (i.e., a length of the current supply period) is cotenant, a value obtained by subtracting the second term on the right side corresponding to the charging voltage of the parasitic capacitance from Vx(t4), i.e., V0=(R_{g}+R_{gint})·I_{g} in the first term on the right side is dependent on the resistance value (R_{g}+R_{gint}). Note that the temperature dependency of the parasitic capacitance is usually small, and thus, the charging voltage of the parasitic capacitance can be regarded as a constant value.

Therefore, the resistance value (R_{g}+R_{gint}) can be calculated using a voltage value V1 of detection voltage Vdet at time t4, the time difference between times t3 and t4, and known I_{g} corresponding to the output current of current supply 11.

Here, each of resistance values Rₜ and Res has temperature dependency. When each of resistance values R_{g} and R_{gint} has linear temperature dependency, resistance values R_{g}(T) and R_{gint} at temperature T are represented as R_{g}(T)≈R_{g}0·(1+K₁·T) and R_{gint}(T)≈R_{gint}0·(1+K₂·T) using a temperature coefficient K.

If the temperature dependency of resistance value Rᵢ other than the internal gate resistance of power semiconductor element 10 is sufficiently smaller than the temperature dependency of internal gate resistance value R_{gint} of power semiconductor element 10, i.e., if ΔR_{g}<ΔR_{gint} (K₁<K₂) fora difference in resistance values caused by temperature T, the temperature dependency of the resistance value (R_{g}+R_{gint}) represents the temperature dependency of the internal gate resistance of power semiconductor element 10. As described above, K₁<K₂ can be achieved by selecting the resistance element (e.g., resistance element 21) externally attached to power semiconductor element 10 to provide resistance value R_{g}.

Therefore, the estimated temperature of power semiconductor element 10 can be calculated by comparing the resistance value (R_{g}+R_{gint}) obtained by the above-described calculation with calibration data representing the relationship between resistance values and temperatures recorded in advance. The calibration dab described above can be acquired by, for example, obtaining the resistance value (R_{g}+R_{gint}) in a manner similar to the manner described above when power module 101 is installed in a thermostatic bath and the element temperature of power semiconductor element 10 is changed from the outside.

When it is difficult to acquire calibration data, a rate of change (temperature coefficient K₂) of internal gate resistance value Rpm due to temperature is acquired in advance as information indicating the relationship between temperatures and resistance values of power semiconductor element 10, and the calculation using the calculated resistance value (R_{g}+R_{gint}) and temperature coefficient K₂ (K₂>K₁) acquired in advance is performed, whereby the temperature of power semiconductor element 10 can be calculated.

In a case where each of the output current (I_{g}) of current supply IL and the time difference between times t3 and t4 (length of the current supply period by current control unit 1) is maintained constant, only the resistance value (R_{g}+R_{gint}) is included in detection voltage Vdet as a variable in response to the temperature change of power semiconductor element 10. Therefore, the information indicating the relationship between temperatures and resistance values of power semiconductor element 10 can also be set in advance so as to directly calculate the estimated temperature from detection voltage Vdet or V0 extracted from detection voltage Vdet, without calculating the resistance value (R_{g}+R_{gint}).

### (Temperature Measurement Daring Off-Period)

Next, temperature measurement during the off time will be described. In FIG. 5, when driver input signal 411 changes from the H level to the L level at time t5 corresponding to the turn-off command timing, switch control signal 31 switches from the H level to the L level at time t6 after a lapse of a certain delay period from time IS. As described above, this delay time can be simply set as a time constant determined by the resistance value of resistance element 21 and the element capacitance of power semiconductor element 10 or longer.

When switch control signal 31 changes from the H level to the L level at time t6, current control switch 12 of current control unit 1 (FIG. 1B and the like) is turned off. As a result, the current from current supply 11 flows not to reference potential node 90 but to power semiconductor element 10. That is, current control unit 1 supplies the current between, control terminal G and negative electrode terminal S, and the current supply period is provided during the of period.

When current control switch 12 is turned offend current injection from current supply 11 to power semiconductor element 10 is started, input voltage Vx of peak detection circuit 5 changes in accordance with Expression (1) above. Note that time t3 in Expression (1) is replaced with time t6.

Thus, similarly to the above-described situation slier time 13, also in the current supply period provided after time t6, input voltage Vx of peak detection circuit 3 and detection voltage Vdet of voltage detection unit 6 are a sum of the constantly generated voltage V0=(R_{g}+R_{gint})·I_{g} and (t-t6)·I_{g}/C_{die}, which is the charging voltage of the parasitic capacitance of power semiconductor element 10, and rise due to charging of the parasitic capacitance with a time lapse from time 16. That is, the behaviors of input voltage Vx and detection voltage Vdet after time t6 are the same as those after time t3.

Similarly to the measurement during the on-period, when switch control signal 31 changes from the L level to the H level at time t7, current control switch 12 is turned on in current control unit 1, and thus, input voltage Vx of peak detection circuit 5 becomes zero (Vx=0). On the other hand, discharge switch 53 is maintained off in peak detection circuit 5 until time t7x at which switch control signal 31 changes from the L level to the H level. Therefore, after time t7, detection voltage Vdet of voltage detection unit 6 is maintained at the voltage value at time t7.

Therefore, as described with regard to the on-period, in the off-period as well, the resistance value (R_{g}+R j.$) can be calculated using a voltage value V2 of detection voltage Vdet from times t7 to t7x, a time difference between times (6 and t7 (length of the current supply period), and known I_{g} corresponding to the output current of current supply 11.

As described above, by designing semiconductor device 100 such that the temperature dependency of resistance value R_{g} other than the internal gate resistance of power semiconductor element 10 is sufficiently smaller than the temperature dependency of internal gate resistance value R_{gint} of power semiconductor element 10, the estimated temperature of power semiconductor element 10 can be calculated by comparing the resistance value (R_{g}+R_{gint}) obtained by calculation with calibration data representing the relationship between resistance values and temperatures recorded in advance. Alternatively, as described above, the temperature of power semiconductor element 10 can also be calculated using temperature coefficient K₂ (K₂>K₁) of internal gale resistance value R_{gint} obtained in advance and the calculated resistance value (R_{g}+R_{gint}).

In addition, as described with regard to the on-period, in a case where each of the output current (I_{g}) of current supply 11 and the time difference between times t6 and t7 (length of the current supply period by current control unit 1) is maintained constant, the estimated temperature can also be directly calculated from detection voltage Wet or V0 extracted from detection voltage Vdet, without calculating the resistance value (R_{g}+R_{gint}).

In the example of FIG. 3, the timing at which switch control signal 31 shifts from the H level to the L level (timing at which current supply from current supply 11 is started) is synchronized with the timing at which switch control signal 35 shifts from the H level to the L level (corresponding to the timing at which voltage detection is started). However, a certain time difference can also be provided between these timings.

In addition, as illy in FIG. 5, the length from times U to t4x and the length from times t6 to t7x (i.e., the length of the current supply period) required for temperature measurement during the on-period and the off-period are obtained by subtracting the period length required for on/off shift of current control switch 12 and the period length required for on/off shift of discharge switch 53 from the length of the on-period or the off-period during switching, and can be set to approximately several microseconds to several hundreds of microseconds, for example.

### [Effect of First Embodiment]

As described above, power module 101 according to the embodiment measures a peak voltage between control terminal G or negative electrode terminal S and reference potential node 90 when current t is injected from current supply 11 to a path between control terminal G and negative electrode terminal S during the on-period or the off-period of power semiconductor element 10 thereby being capable of stably estimating the temperature of power semiconductor element 10. The timing of starting the injection of the currant can be determined as a time point after the Lace of a delay time from the rise timing or fall timing of the driver voltage, the delay time being simply set as a time constant of the gate resistance and the element capacitance or a time longer than or equal to the time constant.

### Modification of First Embodiment.

A modification of the first embodiment will describe a modification of a configuration of peak detection circuit 5.

FIG. 6 is a circuit diagram describing a configuration of peels detection circuit 5 according to the modification of the first embodiment. In the modification of the first embodiment, peak detection circuit 5 has the configuration illustrated in FIG. 6 in semiconductor device 100 in FIG. 1A.

As illustrated in FIG. 6, in peak detection circuit 5 according to the modification of the first embodiment, discharge switch 53 in the circuit configuration in FIG. 4 is replaced with a resistance element 54. That is, in the modification of the first embodiment, on/off control of discharge switch 53 is unnecessary, which leads to the simplified configuration of peak detection circuit 5.

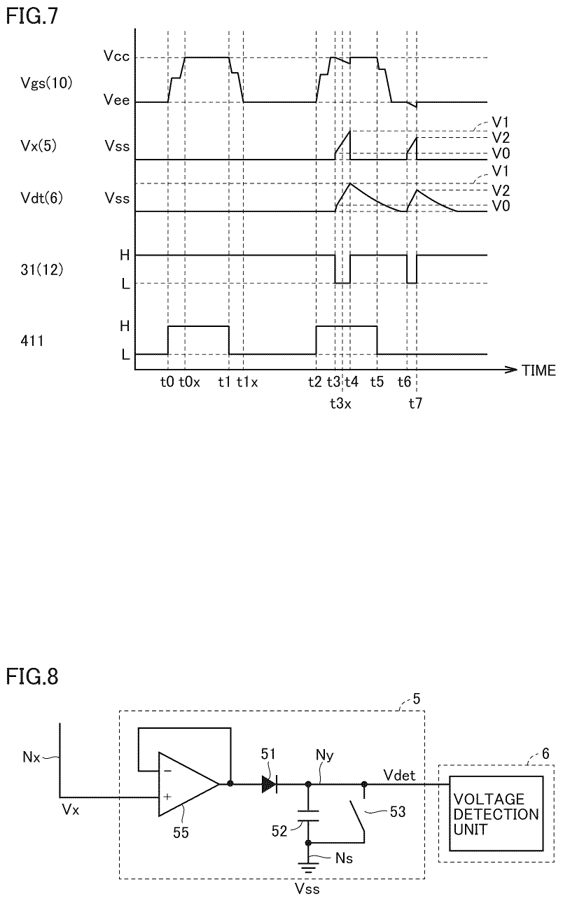

FIG. 7 is a timing chart for describing a temperature estimation method by a semiconductor device according to the modification of the first embodiment.

Referring to FIG. 7, in the modification of the first embodiment, a voltage waveform of capacitor 52 in peals detection circuit 5 changes, and thus, a waveform of detection voltage Vdet of voltage detection unit 6 changes from dot in the first embodiment (FIG. 5). Since the other signal waveforms and voltage waveforms in FIG. 7 are the same as those in FIG. 5, the detailed description thereof will not be repeated.

In FIG. 7. capacitor 52 is discharged through resistance element 54 from time t4 during the on-period and time 17 during the off-period, at which current control switch 12 of current control unit 1 is turned off in response to switch control signal 31. As a result, detection voltage Vdet decreases gradually in accordance with an RC time constant determined by a capacitance value of capacitor 52 and a resistance value of resistance element 34.

In the modification of the first embodiment, the timing of scrupling the voltage value for calculating the resistance value (R_{g}+Rₐw) is fixed with respect to detection voltage Vdet illustrated in FIG. 7 such that the elapsed time, from time t4 or t7 is constant.

As a result, an influence of discharging of capacitor 52 can be eliminated and a variation of voltage V0=(R_{g}+R_{gint})·I_{g} caused by the temperature change of power semiconductor element 10 can be extracted Note that voltage detection unit 6 can preferably acquire voltage values V1 and V2 in the first embodiment (FIG. 5) by sampling detection voltage Vdet simultaneously with or immediately after time t4 or t7.

Thus, also in die modification of the first embodiment in which peak detection circuit 5 his the simplified configuration, the temperature of power semiconductor element 10 can be stably obtained during the on-period or the off-period of power semiconductor element 10, similarly to the first embodiment.

Note that the above-described RC time constant in peak detection circuit 5 needs to be set such that capacitor 52 is discharged within a period (e.g., a half of a switching cycle) determined by a switching cycle (period length from times t0 to t2 in FIG. 7) of power semiconductor element 10. For example, capacitor 52 and resistance element 54 are preferably designed such that discharging of capacitor 52 is completed in several microseconds to several hundreds of microseconds.

In contrast, in peak detection circuit 5 according to the fast embodiment, detection voltage Vdet is maintained constant after times t4 and t7. Therefore, it can be expected that a simple detector that is slow in time response speed is used to constrict voltage detection unit 6 more inexpensively than the modification of the first embodiment.

### Second Embodiment

A second embodiment will describe a further modification of the configuration of peak detection circuit 5.

FIG. 8 is a circuit diagram describing a first configuration example of a peak detection circuit according to the second embodiment.

As illustrated in FIG. 8, peak detection circuit 3 according to the first configuration example of the second embodiment further includes an operational amplifier 55, in addition to the configuration illustrated in FIG. 4. Operational amplifier 55 is connected between input node Nx and diode 51 (anode).

Operational amplifier 33 is connected in a voltage follower connection manner and transmits the voltage of input node Nx to the anode of diode 51. Therefore, input voltage Vx that is the same as that in the first embodiment is input to diode 51. Therefore, detection voltage Vdet by voltage detection unit 6 is the same as that in the first embodiment, and the temperature of power semiconductor element 10 can be stably obtained during the on-period or the off-period of power semiconductor element 10 using the same method as that in the fat embodiment.

In the circuit configuration in FIG. 4, a put of the current from current control unit 1, i.e., the supply current (I_{g}) from current supply 11 flows between input node Nx and node Ns that are connected in parallel to current supply 11, and is used for charging of capacitor 52. Therefore, when the tune is estimated from the relationship of Expression (1) above, the accuracy of temperature estimation may deteriorate due to an error corresponding to the current flowing through peak detection circuit 5.

In contrast, in the circuit configuration in FIG. 8, an input stage having a high impedance is connected to input node Nx, which makes it possible to prevent the supply current from current supply 11 from flowing through peak detection circuit 5. By using an active element such as operational amplifier 55 having a high input impedance in the input stage to increase the input impedance of peak detection circuit 5 as described above, almost all of the supply current from current supply 11 can be passed through power semiconductor element 10. That is, operational amplifier 55 corresponds to an example of “impedance conversion circuit”.

As a result, in the semiconductor device including the peak detection circuit according to the fast configuration example of the second embodiment, an error of the temperature calculated in accordance with the relationship of Expression (1) can be reduced and the accuracy of estimating the temperature of power semiconductor element 10 can be improved.

FIG. 9 is a circuit diagram describing a second configuration example oldie peak detection circuit according to the second embodiment.

As illustrated in FIG. 9, peak detection circuit 5 according to the second configuration example of the second embodiment further includes a diode 36 having the same characteristics as those of diode 51, and an operational amplifier 58, in addition to the configuration illustrated in FIG. 8 (first configuration example).

Diode 56 is inserted into and connected to a return path of operational amplifier 55 connected in a voltage follower connection manner, and causes a voltage drop equivalent to that of diodes 1. A negative bias voltage (V−) for stably bringing diode 56 into conduction may be supplied to a cathode of diode 36 through a resistance element. Diode 56 corresponds to an example of “second diode”.

With such a configuration, an influence of the voltage drop caused by diode 51 can be eliminated and a difference between a voltage of node Ny and an output voltage of operational amplifier 55 (i.e., a voltage of input node Nx) can be reduced. As a result, a difference between detection voltage Vdet by voltage detection unit 6 and input voltage Vx of peak detection circuit 3 can be reduced, and thus, the accuracy of estimating the temperature of power semiconductor element 10 can be further improved.

Operational amplifier 38 is connected between node Ny and voltage detection unit 6. Operational amplifier 581s connected in a voltage follower connection meaner, and outputs a voltage equivalent to the voltage of node Ny to voltage detection unit 6 as detection voltage Vdet. By arranging operational amplifier 58, an output impedance of peak detection circuit 5 decreases. As a result, higher voltage detection accuracy in voltage detection unit 6 is expected. In addition, since it is also possible to prevent the potential of node Ny from changing due to the influence from voltage detection unit 6, higher accuracy of detection of detection voltage Vdet can also be achieved from this perspective.

Note that operational amplifier 58 can also be additionally connected between node Ny and voltage detection unit 6 in the first configuration example illustrated in FIG. 8. Operational amplifier 58 also corresponds to an example of “impedance conversion circuit”.

As described above, by using the peak detection circuit according to the second embodiment, the voltage change caused by the temperature change of power semiconductor element 10 is directly reflected in detection voltage Vdet more clearly, and thus, the accuracy of estimating the temperature of power semiconductor element 10 can be Ruther improved. In the configuration examples in FIGS. 8 and 9, discharge switch 53 can also be replaced with resistance element 54, similarly to FIG. 6 (modification of the first embodiment).

### Third Embodiment

A third embodiment will describe a modification of on/off control of current control switch 12 of current control unit 1. The first embodiment has described the example in which one off-period of current control switch 12 is provided during each of the on-period and the off-period as a period in which the gate voltage of power semiconductor element 10 is stable, other than the rise and fall periods. However, in the third embodiment, a plurality of off-periods of current control switch 12 are provided.

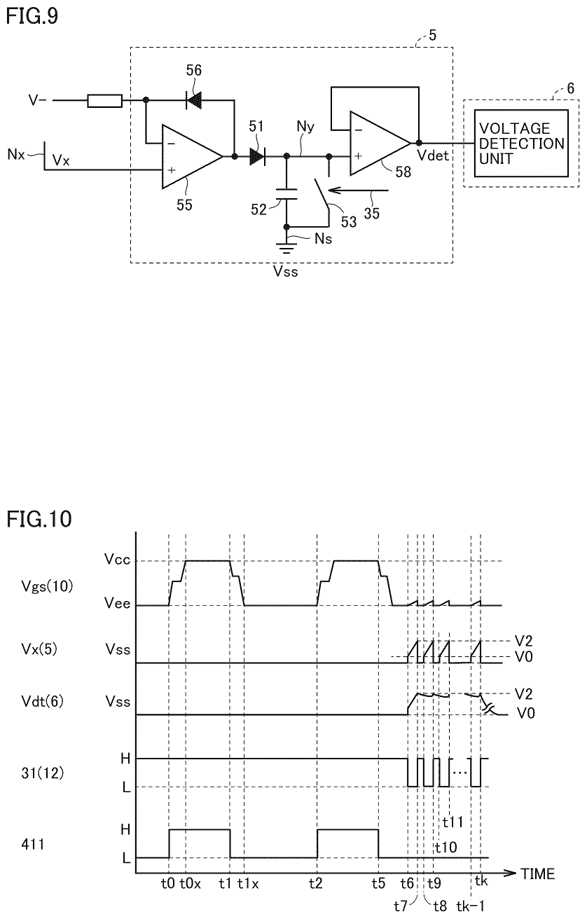

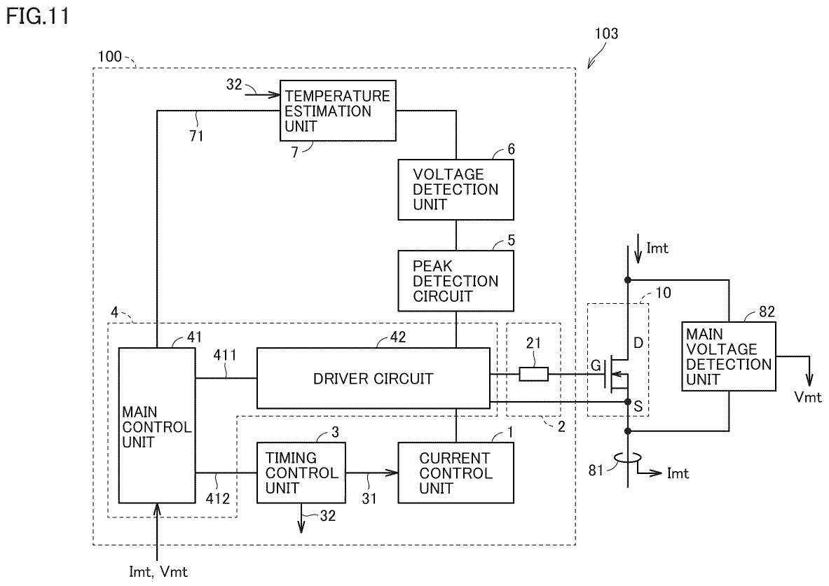

FIG. 10 is a timing chart for describing a temperature estimation method by a semiconductor device according to the third embodiment. In FIG. 10, a plurality of off-periods of current control switch 12, i.e., a plurality of current supply periods by current supply 11 are provided during the off-period of power semiconductor element 10.

In the example of FIG. 10, temperature nit is performed during the off-period aft time t5 at which power semiconductor element 10 is turned off. Specifically, similarly to FIG. 5, over a period from time t6 to time t7 after a lapse of a certain delay period from time t5 corresponding to the turn-off command timing, switch control signal 31 is set to the L level and a current supply period by current control unit 1 is provided. As described in the firm embodiment, in this current supply period, the current is supplied from current supply 11 to power semiconductor element 10 via gate wiring unit 2, so that input voltage Vx of peak detection circuit 3 rises in accordance with Expression (1) above.

At time t7, switch control signal 31 changes from the L level to the H level. In an H-level period of switch control signal 31, current control switch 12 is turned on in current control unit 1 and both ends of current supply 11 have the same potential, and thus, input voltage Vx becomes zero (Vx=0).

After time t7, an L-level period of switch control signal 31 is again provided over a period from times t8 to S. Furthermore, at time t9. switch control signal 31 changes from the L level to the H level, and thereafter, the L-level period of switch control signal 31 is again provided over a period from times t10 to t11.

In the L-level period of switch control signal 31 ova each of the period from times t8 to t9 and the period from times t10 to t11, input voltage Vx of peak detection circuit 3 rises in accordance with Expression (1) above, similarly to the period from times t6 to t7.

As described above, in the example of FIG. 10, the plurality of L-level periods of switch control signal 31, such as the periods from times t6 to t7, from times t8 to t9, from times t10 to t11, . . . , from times tk-1 to tk, i.e., the plurality of current supply periods by current control unit 1 by turning off current control switch 12 are provided during the off-period. Time lengths of the L-level periods of switch control signal 31 we set to be equal to each other. Therefore, the behavior (waveform) of input voltage Vx is the same in each of the L-level periods of switch control signal 31. Therefore, input voltage Vx at the end of each of the L-level periods of switch control signal 31 has the same voltage value V2.

Also in peak detection circuit 5 illustrated in FIG. 5, when diode 51 is brought out of conduction during the off-period of discharge switch 53, the voltage of node Ny actually decreases gradually due to a leakage current of discharge switch 53, or the like. FIG. 10 also emphasizes a slight decrease in detection voltage Vdet caused by the gradual decrease. For example, after time t7, Vx becomes zero (Vx=0) and diode 51 is brought out of conduction, which causes detection voltage Vdet to gradually decrease from V2.

Since the L-level period of switch control signal 31 is provided over the period from times t8 to t9, input voltage Vx riser similarly to the period from times t6 to t7. As a result, when input voltage Vx again becomes higher than the voltage (detection voltage Vdet) of node Ny, diode 51 is brought into conduction and detection voltage Vdet can return to V2 at about time V.

As described above, according to the third embodiment, by turning on and off current control switch 12 a plurality of number of times and repeatedly providing the plurality of current supply periods, attenuation of the output voltage of peals detection circuit 5, i.e., detection voltage Vdet of voltage detection unit 6 can be canceled out. As a result, a simple detector that is slow in time response speed can be used as voltage detection unit 6. Note the this operation of turning on and off current control switch 12 can be repeated over the entire period in which the gate voltage of power semiconductor element 10 is stable, other than the rise period and the fall period, i.e., during the entire off-period and during the entire on-period.

For the sake of simplification of the description, FIG. 10 shows the example in which the off-period of current control switch 12 (current supply period by current control unit 1) is not provided during the on-period and temperature measurement is not performed. However, temperature measurement can be performed both during the on-period and during the off-period, and a plurality of off-periods of current control switch 12 (current supply periods by current supply 11) can be provided in at last one of the temperature measurements.

In addition, in the third embodiment, a response delay of peak detection circuit 5 can also be mitigated by repeatedly turning on and off current control switch 12 a plurality of tunes. Particularly, in peak detection circuit 5 illustrated in FIG. 6, the response speed is limited by the RC time constant determined by capacitor 52 and resistance element 54, and when input voltage Vx does not have so many pulses, the peak value of input voltage Vx may become higher than the output voltage (detection voltage Vdet) of peak detection circuit 5. In order to address this, by repeatedly turning on and off current control switch 12 a plurality of times as in the third embodiment, a plurality of pulse waveforms can be provided as input voltage Vx, and thus, peak detection circuit 5 can accurately reflect the peak value of input voltage Vx in detection voltage Vdet.

Note that the length of the off-period of current control switch 12 cannot in some cases have exactly the sane value due to an influence of jitter or the like of a controller. When the length of the off-period varies, a change factor other than the temperature of power semiconductor element 10 is included in the peak value of input voltage Vx, which raises a concern about degradation of the temperature estimation accuracy. Even in such a case, by providing the off-period of current control switch 12, i.e., the measurement period of input voltage Vx within one off-period or on-period as in the third embodiment, an influence of an error caused by jitter can be averaged. As a result, the degradation of the temperature estimation accuracy can be avoided.

### Fourth Embodiment

A fourth embodiment will describe an example in which the calculated value of the estimated temperature of power semiconductor element 10 calculated in each of the first to third embodiments is used to calculate a steady-state thermal resistance or a transient thermal resistance of power semiconductor element 10.

When the steady-state thermal resistance is calculated, power semiconductor element 10 needs to be in a thermally steady state (thermal equilibrium state). This steady state can, for example, be achieved by passing a certain DC current through power semiconductor element 10 to thereby produce a certain power loss as in a power cycle teat, which is one of the general reliability tests for power semiconductor elements.

Alternatively, a pseudo thermal equilibrium state can also be created by continuously switching power semiconductor element 10 to thereby control a current flowing through power semiconductor element 10 to a fixed amount. For example, a pseudo thermal equilibrium state can be created by controlling a current of each power semiconductor element to a fixed amount in a configuration in which four power semiconductor elements are used to control a conduction direction of a current like a full bridge circuit, or a configuration in which an inductive load or a resistive load is connected to a half-bridge circuit including two power semiconductor elements.

FIG. 11 is a configuration diagram illustrating an example of a power module according to the fourth embodiment.

As illustrated in FIG. 11, a power module 103 according to the fourth embodiment further includes a main current detection unit 81 for measuring main current Imt, and a main voltage detection unit 82 for detecting a main voltage (drain-source voltage) Vmt of power semiconductor element 10, in addition to the configuration of power module 101 or 102 (FIG. 1A, FIG. 3) according to the first embodiment. Main current tint measured by main current detection unit 81 and main voltage Vmt detected by main voltage detection unit 82 are input to main control unit 41. Thus, main control unit 41 can calculate a power loss produced in power semiconductor element 10, using a product of main voltage Vmt and main current Imt.

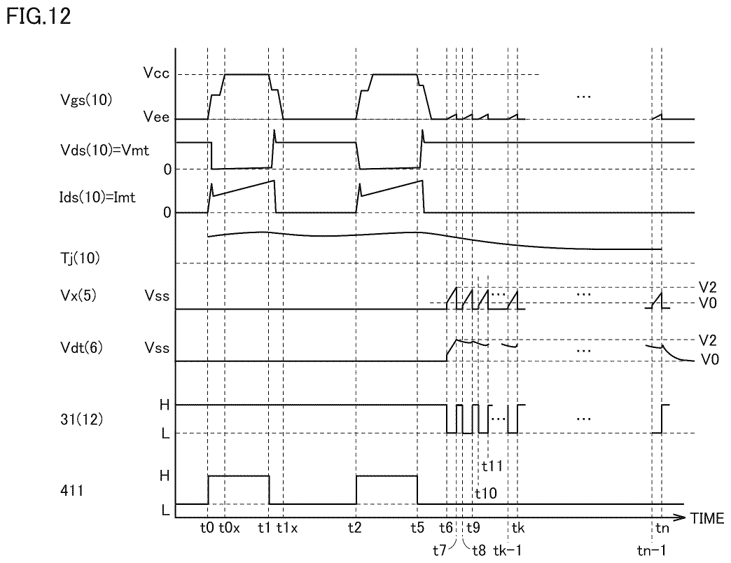

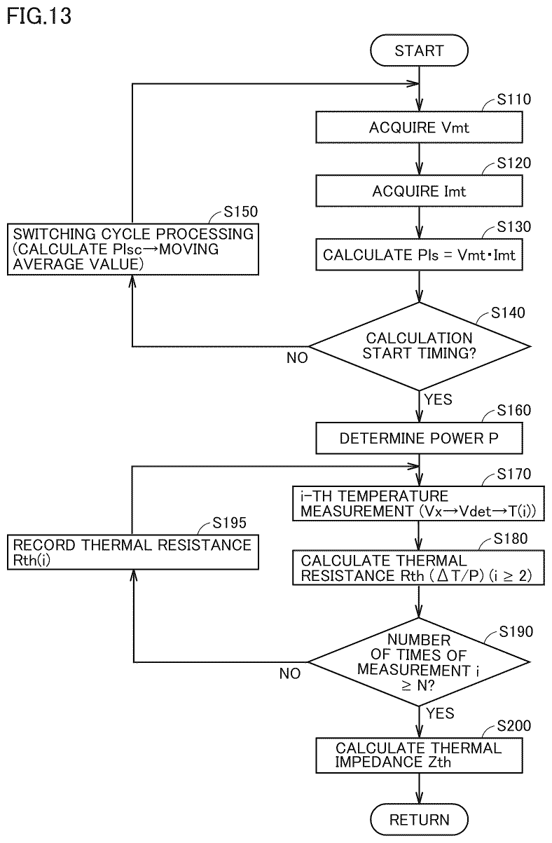

FIG. 12 is a timing chart for describing a thermal resistance and thermal impedance estimation method by a semiconductor device according to the fourth embodiment. A control process illustrated in FIG. 12 can be performed by main control wilt 41, for example.

Referring to FIG. 12, power semiconductor element 10 is switching-controlled a plurality of times until time t3 such that the above-described thermal equilibrium state is formed. Then, power semiconductor element 10 is maintained in the off state after time 15.

In the off-period of power semiconductor element 10, Vmt is generated and Imt=0. Conversely, in the on-period of power semiconductor element 10, Imt is generated and a finite resistance (on resistance) is generated in power semiconductor element 10. Therefore, in the on-period, a power loss (conduction loss) of Pls=Vmt·Imt occurs due to the above-described on resistance. Furthermore, in turn-on and turn-off, a period in which Vmt·tint is not zero occurs and a power loss (switching loss) of Pls=Vmt·Imt occurs in this period. Due to these power losses Pls, temperature Tj of power semiconductor element 10 rises.

Since the current does not flow through power semiconductor element 10 after time t5, temperature Tj of power semiconductor element 10 decreases gradually in accordance with a thermal impedance between power semiconductor element 10 and a not-shown cooler and the cooling capability of die cooler.

A time constant of the temperature change at this time can be simply estimated from a thermal resistance and a thermal capacity of a heat dissipation path of power semiconductor element 10. Generally, the above-described time constant is approximately several tens of microseconds to several hundreds of microseconds in the vicinity of power semiconductor element 10. Generally, this value is a value close to the switching cycle of power semiconductor element 10, or is longer than the switching cycle. In the first to third embodiments described so far, estimating the temperature of power semiconductor element 10 during the on/off operation is assumed, and thus, the temperature change of power semiconductor element 10 during temperature measurement is almost negligible.

In contrast, in the fourth embodiment, the temperature change of power semiconductor element 10 maintained in the off state for a long time is measured using the method described in the third embodiment, thereby measuring a trammel resistance and a thermal impedance of power semiconductor element 10.

Specifically, current control switch 12 is repeatedly turned on and off such that a plurality of L level periods (i.e., current supply periods) each having a predetermined certain length are provided in switch control signs 31 after time tb similarly to FIG. 10. As described in the first to third embodiments, in each off-period of current control switch 12, input voltage Vx that reflects temperature Tj at the time point is generated by the current supply from current control unit 1 (current supply 11).

Therefore, by acquiring the peak value of input voltage Vx from detection voltage Vdet for each current supply period in which current control switch 12 is turned off, the estimated temperature (estimated value of Tj) of power semiconductor element 10 at each timing can be calculated. In the example of FIG. 12, N (N: an integer greater than or equal to 2) temperature measurements are performed during a period from the first L level period (from times tb to t7) to the N-th L level period (front times tn−1 to tn).

Since power semiconductor element 10 is maintained in the off state after time t5, power semiconductor element 10 is gradually cooled. Therefore, the peak value of input voltage Vx and detection voltage Vdet decrease gradually in response to the temperature element of power semiconductor element 10. In order to calculate the decrease in temperature Tj based on the decrease in detection voltage Vdet, peak detection circuit 5 needs to have a response speed that can reflect the decrease in peak value of input voltage Vx caused by the decrease in temperature of power semiconductor element 10 in detection voltage Vdet. Therefore, a response time constant of peak detection circuit 5 is preferably shorter than a thermal time constant of power semiconductor element 10.

FIG. 13 is a flowchart describing a thermal resistance and thermal impedance calculation process by the semiconductor device according to the fourth embodiment. A series of process illustrated in FIG. 13 is performed by main control unit 41, for example.

Main control unit 41 performs the processing in step (hereinafter, simply denoted as “S”) 110 to S150 when power semiconductor element 10 is in the above-described thermal equilibrium date. In FIG. 12, the processing in S110 to S150 is performed before time t5.

Main control unit 41 acquires main voltage Vmt (instantaneous value) of power semiconductor element 10 measured by main voltage detection unit 82 in S110, and acquires main current Imt (instantaneous value) of power semiconductor element 10 measured by main current detection unit 81 in S120. Since main voltage Vmt acquired in S110 and main current Imt acquired in S120 are the measurement values at the same timing, main control unit 41 calculates power loss Pls (instantaneous value) produced in power semiconductor element 10 from a multiplied value of main voltage Vmt and main current Imt in S130.

Until the timing of calculation of the thermal resistance comes, main control unit 41 makes a determination of NO in S140. When main control unit 41 makes a determination of NO in S140, main control unit 41 performs the processing for calculating power loss Plsc for each switching cycle of power semiconductor element 10 in S150. Specifically, by summing power loss Pls calculated in Si 30 within each switching cycle, power loss Plsc for each switching cycle is calculated. In S150, the summed value is cleared in response to the end or start of each switching cycle.

In the example of FIG. 12, a determination of YES in S140 is made at time t3. Until a determination of YES is made in S140, the processing in S110 to S150 is repeatedly performed. In S150, a moving average value of power loss Plsc in the latest X cycles (X: a predetermined integer greater than or equal to 2) may be further obtained.

When a determination of YES is made in S140, main control unit 41 moves the process to S160 and starts to calculate the thermal resistance. In S160, main control unit 41 determines power P (W) used to calculate a thermal resistance Rth. For example, power P can be power loss Plec in the immediately preceding switching cycle calculated in Si 50 or the latest moving average value of power loss Plsc when a determination of YES is made in S140.

As described with reference to FIG. 12, for each L level period (equal length) of switch control signal 31, main control unit 41 calculates the estimated temperature (estimated value of Tj) of power semiconductor element 10 from detection voltage Vdet obtained as the peak value of input voltage Vx. Here as described with reference to FIG. 12, it is assumed that a total of N temperature measurements are performed.

In S170, main control unit 41 performs the i-th (i: a natural number from 1 to N) temperature measurement and calculates an estimated temperature T(i) from detection voltage Vdet at this time point. In FIG. 12, when i=1, an estimated temperature T(1) of power semiconductor element 10 at times t6 to t7 is calculated.

When i≥2, thermal resistance Rth=ΔT/P is calculated in S180 using a temperature variation ΔT(i)=T(i)−T(1) and power P determined in S160. In S180, a thermal resistance Rth(i) is calculated in the i-th temperature measurement (i≥2).

In S190, main control unit 41 determines whether the number of times of measurement i satisfies a predetermined end condition (N). Until the measurement end condition is satisfied (NO in S190), thermal resistance Rth(i) calculated in S180 is recorded in S195. Therefore, when the number of times of measurement i reaches n and the measurement end condition is satisfied (YES in S190), (N-1) thermal resistances Rth(2) to Rth(N) have already been acquired. Note that the measurement end condition in S190 may be set based on the number of times of measurement, or may be sat based on a length of the elapsed time from when a determination of YES is nude in S140.

When the measurement end condition is satisfied (YES in S190), main control unit 41 can calculate thermal impedance Zth of power semiconductor element 10 including the cooling system, using the thermal resistances (here. Rth(2) to Rth(N)) that have been calculated until then in response to the temporal change in temperature Tj of power semiconductor element 10. As described above, main control unit 41 performs the control process illustrated in FIG. 13, whereby an example of “thermal resistance calculation unit” can be formed.

In order to calculate the thermal impedance, it is necessary to sot the measurement end condition in S190 such that the sufficient cooling time of power semiconductor element 10 is ensured. Although the required cooling time depends on the thermal time constant of die cooling system of power semiconductor element 10, the required cooling time is generally the order of several seconds to several hundreds of seconds. It is difficult to incorporate the cooling time of this order into a normal operation node of a general power electronics device. However, by making use of, in an inverter system, current control or the system operation stop timing such that a power semiconductor element can be maintained off over a curtain period, for example, the off state of power semiconductor element 10 can be maintained for a relatively long period and the thermal impedance calculation process illustrated in FIG. 13 can be performed.

As described above, according to the fourth embodiment, thermal resistance Rth of power semiconductor element 10 can be calculated using the temperature estimation method for power semiconductor element 10 described in the first to third embodiments. Furthermore, when the off period (cooling period) of power semiconductor element 10 for temperature measurement can be ensured, thermal impedance Zth of power semiconductor element 10 including the cooling system can be calculated.

### Fifth Embodiment

In a fifth embodiment, power modules 101 to 103 according to the first to fourth embodiments described above are applied to a power conversion device. The fifth embodiment will describe a cage where the present disclosure is applied to a three-phase inverter, although the present disclosure is not limited to a specific power conversion device.

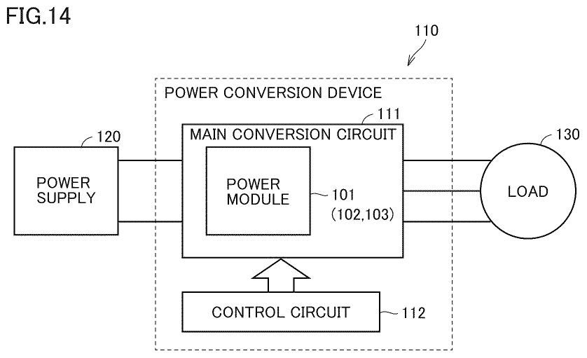

FIG. 14 is a block diagram illustrating a configuration of a power conversion system to which the power conversion device according to the present embodiment is applied.

The power conversion system illustrated in FIG. 14 includes a power supply 120, a power conversion device 110, and a load 130. Power supply 120 is a DC power supply, and supplies DC power to power conversion device 110. Power supply 120 can be of any type. For example, power supply 120 can be a DC system, a solar cell, and a storage battery, or may be constituted by a rectifier circuit or an AC/DC converter connected to an AC system. Alternatively, power supply 120 may be constituted by a DC/DC converter that converts DC power output from the DC system into predetermined power.

Power conversion device 110 is a three-phase inverter connected between power supply 120 and load 130, converts DC power supplied from power supply 120 into AC power, and supplies the AC power to load 130. As illustrated in FIG. 14, power conversion device 110 includes a main conversion circuit lit that converts DC power into AC power and outputs the AC power, and a control circuit 112 the outputs a control signal for controlling main conversion circuit 111 to main conversion circuit 111.

Load 130 is a tree-phase electric motor driven by the AC power supplied from power conversion device 110. Load 130 is not limited to a specific application, and is an electric motor mounted on various electric devices such as an electric motor for a hybrid vehicle, an electric vehicle, a railway vehicle, en elevator, or an air conditioner.

The detail of power conversion device 110 will be described below. Main conversion circuit 111 includes a switching element and a freewheeling diode (not illustrated), converts DC power supplied from power supply 120 into AC power by switching of the switching element, and supplies the AC power to load 130. Although there are various specific circuit structures of main conversion circuit 111, main conversion circuit 111 according to the present embodiment can be a two-level three-phase full bridge circuit including six switching elements and six freewheeling diodes antiparallel to the respective switching elements. At least one of the switching elements of main conversion circuit 111 is power semiconductor element 10 included in power module 101 according to any one of the above-described first to fourth embodiments. The six switching elements are connected in series for every two switching elements to constitute upper and lower arms, and each of the upper and lower arms constitutes each phase (U-phase, V-phase, W-phase) of the MI bridge circuit. The output terminals of the upper and lower anon, that is, the three output terminals of main conversion circuit 111, are connected to load 130.

In addition, since semiconductor device 100 (not illustrated) that drives each switching element is incorporated in power modules 101 to 103 as described in the above first to fourth embodiments, main conversion circuit 111 includes semiconductor device 100. Semiconductor device 100 generates a drive signal for driving the switching elements of main conversion circuit 111, and supplies the drive signal to control electrodes of the switching elements of main conversion circuit 111. Specifically, the drive circuit outputs, to the control electrode of each switching element, a drive signal for turning on the switching element and a drive signal for turning off the switching element in accordance with a control signal from control circuit 112 to be described later. When the switching element is maintained in an on state, the drive signal is a voltage signal (on signal) grater than or equal to a threshold voltage of the switching element, and when the switching element is maintained in an off state, the drive signal is a voltage signal (off signal) less than or equal to the threshold voltage of the switching element.

Control circuit 112 controls the switching elements of main conversion circuit 111 so that desired power is supplied to load 130. Specifically, control circuit 112 calculates, on the basis of power to be supplied to load 130, a time (on-torte) during which each switching element of main conversion circuit 111 is to be turned on. For example, control circuit 112 can control main conversion circuit 111 by pulse width modulation (PWM) control that modulates the on-time of the switching element in accordance with the voltage to be output. Than, control circuit 112 outputs a control command (control signal) to semiconductor device 100 included in main conversion circuit 111 such that, at each time point, the on signal is output to the switching element to be turned on and the off signal is output to the switching element to be tuned off. Semiconductor device 100 outputs the on signal or the off signal as a drive signal to the control electrode of each switching element in accordance with the control signal.

In the power conversion device according to the present embodiment, any one of power modules 101 to 103 according to the first to fourth embodiments is applied as power module 101 constituting main conversion circuit 111, whereby the reliability of the power conversion device can be improved on the basis of the temperature measurement result of the power semiconductor element.

The present embodiment has described the example in which the present disclosure is applied to a two-level three-phase inverter. However, the present disclosure is not limited thereto, and can be applied to various power conversion devices. In the present embodiment, the two-level power conversion device has been described. However, a three-level or multi-level power conversion device may be used, or the present disclosure may be applied to a single-phase inverter in a case where power is supplied to a single-phase load. In addition, in a case where power is supplied to a DC load or the like, the present disclosure can also be applied to a DC/DC converter or an AC DC converter.

In addition, the power conversion device to which the present disclosure is applied is not limited to the one described above used for an electric motor serving as a load, and can be used as, for example, a power supply device of an electric discharge machine, a laser beam machine, an induction eating cooker, or a non-contact power feeding system. Fort, the power conversion device to which the present disclosure is applied can also be used as a power conditioner of a solar power generation system, a power storage system, or the like.

In connection with the plurality of embodiments described above, for confirmation purpose, combination as appropriate of features described in the plurality of embodiments described above including combination not mentioned in the specification is also originally intended within the scope where there is no inconsistency or contradiction.

It should be understood that the embodiments disclosed herein are illustrative and non-restrictive in every respect. The scope of the present disclosure is defused by the terms of the claims, rather then the description above, and is intended to include any modifications within the scope and meaning equivalent to the terms of the claims.

### REFERENCE SIGNS LIST

1 current control unit; 2 gate wiring unit; 3 timing control unit; 4 gate drive unit; 5 peak detection circuit; 6 voltage detection unit; 7 temperature estimation unit; 10 power semiconductor element; 11 current supply; 12 current control switch; 20 pulsed current supply; 21, 54 resistance element; 31, 35 switch control signal; 32 control information; 41 main control unit; 42 driver circuit; 51, 56 diode; 52 capacitor; 53 discharge switch; 55, 58 operational amplifier; 71 temperature information; 81 main current detection unit; 82 main voltage detection unit; 90 reference potential node; 100 semiconductor device; 101 to 103 power module; 110 power conversion device; 111 main conversion circuit; 112 control circuit; 120 power supply; 130 load; 411 driver input signal; 412 command; D positive electrode terminal; G control terminal; trot main current (power semiconductor element); Na, Nay Ny node; S negative electrode terminal; Vdet detection voltage; Vgs gate voltage Vmt main voltage (power semiconductor element); Vx input voltage (peak detection circuit).

1. A semiconductor device that drives and controls a semiconductor element,
the semiconductor element having a positive electrode terminal, a negative electrode terminal, and a control terminal, a drive voltage for controlling a main current flowing between the positive electrode terminal and the negative electrode terminal being applied to the control terminal,
the semiconductor device comprising:
a driver circuit to supply the drive voltage to the control terminal to shift the semiconductor element between an on state and an off state;
a current controller provided to pass a current of pulse shape between the control terminal and the negative electrode terminal;
a timing controller to control a timing of supply of the current by the current controller;
a peak detection circuit to output a peak value of an input voltage the input voltage being a potential difference of the control terminal or the negative electrode terminal with respect to a reference potential in a current supply period by the current controller;
a voltage delve ion wait detector to sample an output voltage of the peak detection circuit; and
a temperature unit estimator to calculate an estimated temperature of the semiconductor element based on a detection voltage by the voltage detector,
wherein the timing a controller causes the current controller to operate to provide the current supply period during at least one of an on-period after the semiconductor element shifts to the on state; and an off-period after the semiconductor element shifts to the off state.

2. The semiconductor device according to claim 1, wherein
the peak detection circuit includes:
a first diode having an anode connected to a first node, the first node being electrically connected to the control terminal or the negative electrode terminal;
a capacitor connected between a second node connected to a cathode of the first diode and a node supplying the reference potential; and
a discharge switch element or a discharge resistance to discharge the capacitor.

3. The semiconductor device according to claim 2, wherein
the peak detection circuit further includes an impedance conversion circuit arranged at least one of between the first node and the anode of the first diode; and between the second node and the voltage detector.

4. The semiconductor device according to claim 3, wherein
the peak detection circuit includes, as the impedance conversion circuit, an operational amplifier connected in a voltage follower connection manner between the first node and the anode of the first diode, and
the peak detection circuit further includes a second diode inserted into and connected to a return path of the voltage follower connection and causing a voltage drop equivalent to that of the first diode.

5. The semiconductor device according to claim 1, wherein
the timing controller provides a plurality of the current supply periods during the at least one of the on-period and the off-period.

6. The semiconductor device according to claim 1, wherein
the timing controller repeatedly provides a plurality of the current supply periods within a thermal resistance measurement period in which the semiconductor element is maintained off, and
the semiconductor device hither comprises:
a main current detector to detect the main current of the semiconductor element;
a main voltage detector to detect a main voltage between the positive electrode terminal and the negative electrode terminal of the semiconductor element; and
a thermal resistance calculator to calculate a power loss for each switching cycle that occurs in the semiconductor element before the thermal resistance measurement period, and calculate a thermal resistance of the semiconductor element based on the calculated power loss and a variation of the estimated temperature calculated for each of the plurality of the current supply periods.

7. The semiconductor device according to claim 1, wherein
the current controller is arranged at a position where the current is supplied from the negative electrode terminal side of the semiconductor element.

8. The semiconductor device according to claim 1, wherein
the current controller is arranged at a position where the current is supplied from the control terminal side of the semiconductor element.

9. The semiconductor device according to claim 1, wherein
the current of pulse shape has a predetermined amplitude,
the current supply period is provided to have a predetermined time length, and
the temperature estimator calculates the estimated temperature using a resistance value determined from the detection voltage and the amplitude of the current in the current supply period, and information indicating a preliminarily determined relationship between a temperature of the semiconductor element and the resistance value.

10. A power conversion device comprising:
a main conversion circuit having the semiconductor device as recited in claim 1 and a semiconductor element driven and controlled by the semiconductor device, the main conversion circuit converting and outputting input electric power, and
a control circuit to output a control signal for controlling power conversion by the main conversion circuit to the main conversion circuit.
